(19) United States
(12) Patent Application Publication
(10) Pub. No.: US 2003/0076691 A1
(43) Pub. Date: Apr. 24, 2003

(54) Impact resistant - long life trouble light

(76) Inventors: Eric Roger Becks, Cheboygan, MI (US); Thomas Frederick Gauthier, Cheboygan, MI (US); Donald Lewis Russell, Lebanon, IN (US)

Correspondence Address: FERRET INSTRUMENTS, INC., 1310 HIGGINS DRIVE, CHEBOYGAN, MI, 49721-1061, US

(21) Appl. No.: 09/682,798

(22) Filed: Oct. 19, 2001

(51) Int. Cl. F21V 7/04

(52) U.S. Cl. 362/555

(57) ABSTRACT

A trouble light apparatus constructed in accordance with the principles of the present invention employs high output Light Emitting Diodes to provide improved service over existing trouble lights by having extremely long life lighting elements, being extremely resistant to impacts and shocks that easily damage incandescent and fluorescent lamps, uses low power and does not generate hazardous levels of heat. The invention also anticipates other fabrication methods and the use of various spectra of LEDs to cause diagnostic markers to fluoresce.

### COPYRIGHT STATEMENT

Copyright 2001, Ferret Instruments, Inc.

### BACKGROUND OF INVENTION

Current trouble lights exhibit combinations of the following undesirable properties: lighting elements whether incandescent, florescent or halogen are easily broken by impact from dropping or bumping the fixture which commonly occurs in the work area; the lifetimes of the light elements are very limited requiring the expense and inconvenience of frequent replacement; power required to provide adequate lighting to the work area is high; power utilization by the lighting elements is inefficient generating excess heat in confined work areas; hot lighting fixtures present a safety hazard in confined work spaces. The invention described here eliminates damage due to most common levels of impact or shock, uses extremely long life lighting elements, uses low power, and doesn't generate hazardous levels of heat.

### BRIEF DESCRIPTION OF DRAWINGS

FIG. 1 is a plan view of a trouble light apparatus constructed in accordance with the principles of the present invention.

FIG. 2 is a plan view of an apparatus used to replace the lamp in a conventional trouble light constructed in accordance with the principles of the prsent invention.

FIG. 3 is an electrical schematic of the connections of the Light Emitting Diodes and current limiting devices.

### DETAILED DESCRIPTION

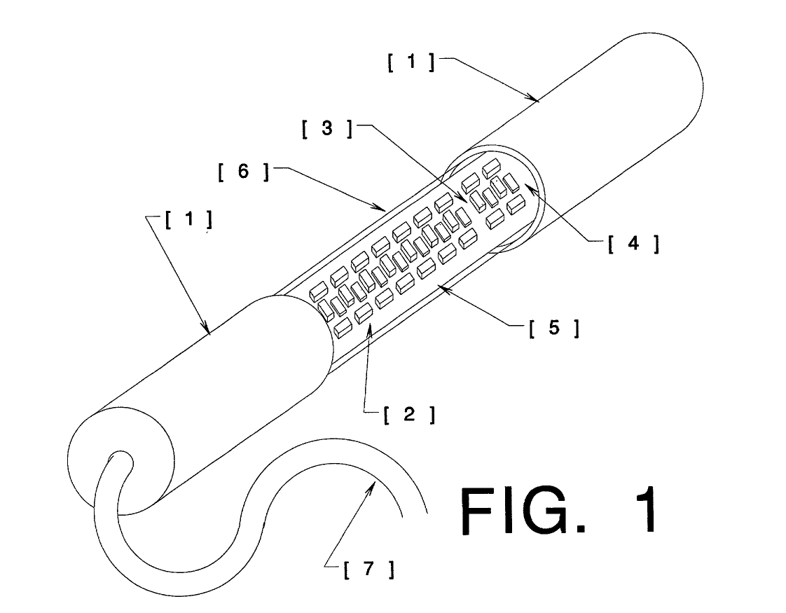

Referring to FIG. 1, there is depicted a trouble light apparatus comprised of multiple, high efficiency Light Emitting Diodes (LEDs) that are not easily damaged by impact and exhibit long useful component life. The first preferred embodiment includes an impact resistant enclosure tube 6 fitted with hand grip end caps 1 to contain the LEDs 2, 3 which are mounted on a circuit board 5 in an arrangement to provide the desired lighting pattern along with current limiting devices 4 and a means of providing power 7.

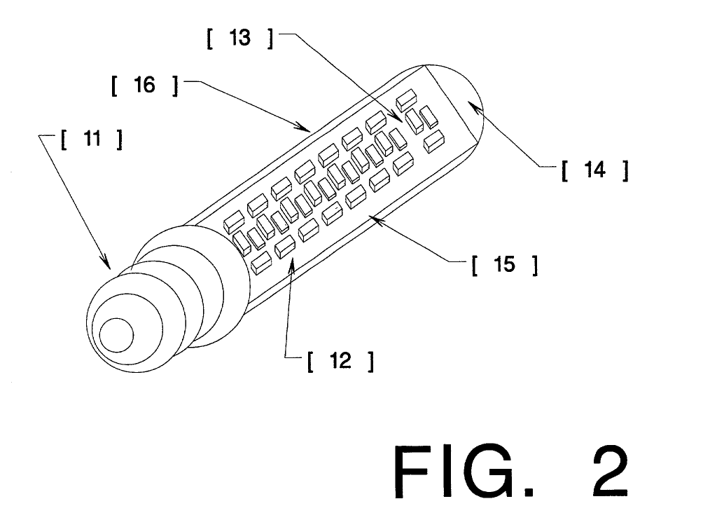

Referring to FIG. 2, this is depicted an apparatus by which a conventional trouble light may be modified to employ the invention described. The second preferred embodiment includes a conventional lamp screw base 11 to allow installation of the apparatus in place of an existing incandescent lamp to provide power, an impact resistant clear enclosure 16 multiple Light Emitting Diodes 12, 13 mounted on a circuit board 15 arranged to provide a desired lighting pattern along with current limiting device (s) 14.

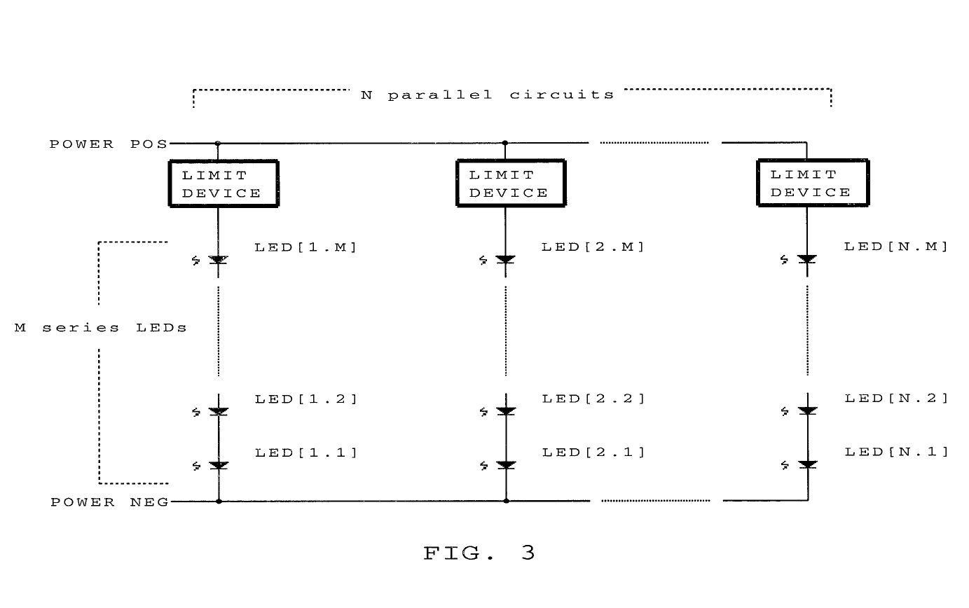

Referring to FIG. 3, which applies to both FIG. 1 and FIG. 2 embodiments, the generalized electrical schematic diagram shows parallel connected stings of series connected groups of LEDs (e.g. LED[1.1] through LED[1.M]) along with limiting devices. By varying the numbers in the parallel and series groups, N and M respectively, the multiple LED arrays can be configured for various power source voltages as well as for total light output.

By including LEDs of specific spectral output among or in place of the standard LED lighting elements 2, 3, 12, 13 the invention also functions to illuminate certain chemicals used in tracing fluids and gases and thus facilitate the tracing of fluids or detection of leaks.

1. A trouble light apparatus using multiple light emitting diodes as the lighting element, comprising:
multiple Light Emitting Diodes arranged to provide a desired pattern of light a mounting arrangement to resist damage by impact

2. A trouble light apparatus using multiple Light Emitting Diodes as the lighting element with the LEDs mounted to a printed circuit board and enclosed within a high impact resistant plastic tube, comprising:
multiple Light Emitting Diodes mounted on a printed circuit board arranged to provide a desired pattern of light
high impact resistant plastic tube to enclose the circuit board
a means to cap the ends of the plastic tube to retain the circuit board

3. [Claim Reference] invention of the first claim where the LEDs are molded or otherwise embedded into the plastic fixture.

4. A device employing multiple LED lighting elements arranged in a form and fitted with appropriate connector to replace the existing incandescent lamp in a conventional trouble light, comprising:
multiple Light Emitting Diodes connected in electrically parallel and series circuits such that the forward voltage drops due to the semiconductor band gap potentials sum to less than the applied voltage
circuit elements, whether passive such as resistors or active such as voltage or current regulators, to adjust for the difference from the applied voltage to the summed band gap potentials of the LED circuits
a physical enclosure of a shape and size equal to or smaller than a conventional incandescent trouble light lamp
a contact base of the type used on conventional incandescent lamps to provide for electrical contact from the conventional trouble light lamp socket

5. A trouble light apparatus, powered by internal batteries, using multiple Light Emitting Diodes as the lighting element, comprising:
multiple Light Emitting Diodes arranged to provide a desired pattern of light batteries and mounting means
a mounting arrangement to resist impact

6. A trouble light apparatus using multiple Light Emitting Diodes as the lighting element, comprising:
multiple Light Emitting Diodes of specific spectral content that are used, either exclusively or along with the basic white LEDs such that certain materials are caused to fluoresce when illuminated by the work light.
